(19) United States
(12) Patent Application Publication
(10) Pub. No.: US 2020/0285716 A1
(43) Pub. Date: Sep. 10, 2020

(54) DETECTION AND MONITORING OF SOFTWARE LICENSE TERMS AND CONDITIONS

(71) Applicant: International Business Machines Corporation, Armonk, NY (US)

(72) Inventors: Gireesh Punathil, Kerala (IN); Vipin M V, Kerala (IN); Subrahmanya C. Paradani, Horamavu (IN); Vijayalakshmi Kannan, Karnataka (IN)

(21) Appl. No.: 16/295,640

(22) Filed: Mar. 7, 2019

(51) Int. Cl. G06F 21/10; G06F 17/27; G06Q 50/18

(52) U.S. Cl. CPC G06F 21/105; G06Q 50/184; G06F 17/2775; G06F 17/2705

(57) ABSTRACT

A system containing a central software enterprise license management (CSELM) server computer, a client agent that acts as a command slave for the CSELM server computer, a desktop monitoring service that has well defined set of monitoring application programming interface (APIs) and tunables or parameters that keep a one-to-one relation with the monitoring APIs, a cloud based software service that provides cognition based services for common license subscriptions. The disclosed methods include abstracting licensing restrictions, generating the set of rules that truly represent the restrictions thus abstracted, configuring and invoking the desktop monitoring agent with the set of rules thus identified for the installation, and reporting, logging or auditing user actions that violate the defined rules thereon.

### BACKGROUND

The present invention relates to detection and monitoring of software actions within an enterprise or organization, and more specifically to detection and monitoring of software license terms and conditions of individual client computers within an enterprise or organization.

Enforcement of license terms and conditions of software products is complicated since software that is licensed is a configurable, modifiable and customizable entity at various levels. Large organizations use many different software products and the licenses associated with the software can be difficult to track, maintain and ensure software usage compliance, given the large number of users within the organization.

Users of licensed software face perpetual challenges in understanding complete licensing terms due to: i) the usage of a large number of software products, ii) each set of license terms for each software product are discretely unique, iii) the license term text is written in legal terms which may not be understandable to all users. As a result, some users' actions may violate license terms of software products they use, which in turn can result in a penalty to the organization.

In order to ensure software users within a large organization are compliant with software licensing terms and conditions, solutions of the prior art restrict only valid users from accessing a licensed, reusable software component, restrict only entitled features of a licensed software component to be accessed, control only valid, viable and capable client devices with access to software, control only entitled features of a licensed software to be accessed, and using of digital signatures to enforce the restriction of specific actions that violate the licensing terms and conditions.

Other prior art solutions use a virtual distribution environment where the stored information can be monitored and controlled via predefined access control mechanisms, however the information or features do not flow through the network when these checks fail.

In yet another prior art solution, an agent collects a software installation record, and generates a software audit result of the client according to the software installation record, the software audit rule and the software release record.

In another prior art solution, the installation count checks are controlled and implied entitlements provide a rule-based catalog for mapping an entitled software offering having software programs and associated constraints to installed software programs. At least one constraint includes an entitled installation count specifying the number of entitled installations of the software programs for the software offering, discovering software programs installed on the hardware in the computer environment with each of the installed software programs each having a base product attribute, a used-in-counts attribute and a parent-child attribute, and with each of the attributes being set or reset, identifying an entitled software offering associated with a discovered installed software program and fetching all other installed software programs in the identified software offering.

In another prior art solution, a template for a rule-based catalog is defined where the constraints of the entitled software are set. This is further used to synchronize between the software entitlements (that change dynamically and on user's demand), and the software offering data that contain the scope of the offering.

In yet another prior art solution, rules and actions are predefined at a rule engine which the configuration manager consults for getting proper actions.

Cognitive abstraction has also been used in the prior art. Cognitive abstraction is the process of abstracting a document into one or more statement that reflect the document. For implementing this abstraction, established cognitive algorithms are used such as abstracting keywords along with nouns, verbs to understand the actual restrictions/actions from the data. Traditional methods of parsing natural language text and make of these techniques with the help of supervised deep learning techniques. A supervised learning here involves feeding of heterogenous types of existing and known texts which are labelled or tagged for its respective actions. Since, some texts mostly follow certain standards in its documentation, abstraction of the text and understanding of its restrictions/actions can always be achieved with the help of existing and known text documents that form the knowledge corpus for abstraction here. Discrete actions inside the engine would involved cleaning, tokenizing, stemming, lemmatizing and vectorizing the data.

The prior art solutions do not cognitively customize controls for custom usage of the subject software for users within an organization based on a defined set rules established by a rules engine from natural language license text, in a dynamic manner without human intervention.

### SUMMARY

According to one embodiment of the present invention, a method of detecting and monitoring of natural language software license terms and conditions within an enterprise system is disclosed. The enterprise system comprising a plurality of client computers each having a client agent with monitoring agent, the client agent of each of the plurality of client computers being in communication with a central software enterprise license management server computer, the central software enterprise license management server computer being in communication with remote hosted services. The method comprising the steps of: the client agent of at least one client computer of the plurality of client computer intercepting installation of software on the at least one client computer and upon installation of the software, extracting installation data comprising: natural language licensing text of software license terms and conditions from the installation of the software and an audit trail associated with the installation of the software; the central software enterprise license management server receiving the installation data from the client agent and parsing the installation data to determine a type of installation of the software on the at least one client computer; the remote hosted services receiving the natural language licensing text and type of installation from the central software enterprise license management server computer and abstracting licensing restrictions from the natural language licensing text; the central software enterprise license management server computer receiving the abstracted licensing restrictions from the remote hosted services and generating a configuration file with a set of rules that represent the restrictions abstracted for implementation by the client agent of the at least one client computer; the client agent invoking the configuration file through the monitoring agent with the set of rules identified for the installation of the software on the at least one client computer; and the monitoring agent reporting, logging or auditing user actions that violate the set of rules of the configuration file identified for the installation of the software on the client computer.

According to another embodiment, a computer program product for detecting and monitoring of natural language software license terms and conditions within an enterprise system is disclosed. The enterprise system comprising a plurality of client computers each having a computer comprising at least one processor, one or more memories, one or more computer readable storage media, a client agent with monitoring agent, the client agent of each of the plurality of client computers being in communication with a central software enterprise license management server computer, the central software enterprise license management server computer being in communication with remote hosted services, the computer program product comprising a computer readable storage medium having program instructions embodied therewith. The program instructions executable by the computer to perform a method comprising: intercepting, the client agent of at least one client computer of the plurality of client computer, installation of software on the at least one client computer and upon installation of the software, extracting installation data comprising: natural language licensing text of software license terms and conditions from the installation of the software and an audit trail associated with the installation of the software; receiving, by the central software enterprise license management server, the installation data from the client agent and parsing the installation data to determine a type of installation of the software on the at least one client computer; receiving, by the cognitive services, the natural language licensing text and type of installation from the central software enterprise license management server computer and abstracting licensing restrictions from the natural language licensing text; receiving, by the central software enterprise license management server computer, the abstracted licensing restrictions from the remote hosted services and generating a configuration file with a set of rules that represent the restrictions abstracted for implementation by the client agent of the at least one client computer; invoking, by the client agent, the configuration file through the monitoring agent with the set of rules identified for the installation of the software on the at least one client computer; and reporting, logging or auditing, by the monitoring agent, user actions that violate the set of rules of the configuration file identified for the installation of the software on the client computer.

According to another embodiment, a computer system for detecting and monitoring of natural language software license terms and conditions within an enterprise system. The enterprise system comprising a plurality of client computers comprising at least one processor, a client agent with monitoring agent, the client agent of each of the plurality of client computers being in communication with a central software enterprise license management server computer, the central software enterprise license management server computer being in communication with remote hosted services, one or more computer readable storage media having program instructions executable by the computer to perform the program instructions. The program instructions comprising: intercepting, the client agent of at least one client computer of the plurality of client computer, installation of software on the at least one client computer and upon installation of the software, extracting installation data comprising: natural language licensing text of software license terms and conditions from the installation of the software and an audit trail associated with the installation of the software; receiving, by the central software enterprise license management server, the installation data from the client agent and parsing the installation data to determine a type of installation of the software on the at least one client computer; receiving, by the cognitive services, the natural language licensing text and type of installation from the central software enterprise license management server computer and abstracting licensing restrictions from the natural language licensing text; receiving, by the central software enterprise license management server computer, the abstracted licensing restrictions from the remote hosted services and generating a configuration file with a set of rules that represent the restrictions abstracted for implementation by the client agent of the at least one client computer; invoking, by the client agent, the configuration file through the monitoring agent with the set of rules identified for the installation of the software on the at least one client computer; and reporting, logging or auditing, by the monitoring agent, user actions that violate the set of rules of the configuration file identified for the installation of the software on the client computer.

### BRIEF DESCRIPTION OF THE DRAWINGS

FIG. 1 depicts an exemplary diagram of a possible data processing environment in which illustrative embodiments may be implemented.

FIG. 2 illustrates internal and external components of a client computer and a server computer in which illustrative embodiments may be implemented.

FIG. 3 shows a schematic of interactions with software licensing monitoring and detection system.

FIG. 4 shows a flow diagram of a method of the central software enterprise license management server detecting and monitoring of software license terms and conditions within an enterprise.

FIG. 5 shows a flow diagram of a method of the cognitive remote based services extracted natural language licensing terms to cognitively analyze software licensing terms.

FIG. 6 shows a flow diagram of a method of the client agent managing the client computer.

FIG. 7 shows a block diagram of an exemplary cognitive services architecture, including a natural language processing system.

### DETAILED DESCRIPTION

In an embodiment of the present invention, a system contains a central software enterprise license management (CSELM) server computer, a client agent that acts as a command slave for the CSELM server computer, a desktop monitoring service that has well defined set of monitoring application programming interface (APIs) and tunables or parameters that keep a one-to-one relation with the monitoring APIs, a cloud based software service that provides cognition remote based services for common license subscriptions. The disclosed methods include cognitively abstracting licensing restrictions from natural language licensing text, generating the set of rules that truly represent the restrictions thus abstracted, configuring and invoking the desktop monitoring agent with the set of rules thus identified for the installation, and reporting, logging or auditing user actions that violate the defined rules thereon.

In an embodiment of the present invention, cognitive abstraction is used to abstract an entire natural language license document into one or more statements that meaningfully reflect the usage restrictions stipulated in the document, normalizing those statements into a set of statements that align to the lexical standards prevalent in the deeply learned cognitive engine, and then mapping each statements into one or more tunables. Tunables keep one-to-one correspondence with exported capability (callable interfaces, also knows as APIs) of the monitoring engine in the desktop device.

For implementing this abstraction, established cognitive algorithms are used such as abstracting keywords along with nouns, verbs to understand the actual restrictions/actions from the data. Traditional methods of parsing natural language text may be used to understand the license text for general rules, restrictions, actions from the text with the help of supervised deep learning techniques.

In an embodiment of the present invention, natural language processing is used on a document that contains statements of legal bindings, extracting the relevant portions of the document that reflect the legal restrictions, transforming those portions into a common vocabulary that is aligned to the trained knowledge of the cognitive engine, and then translating the cleansed data to a set of rules (tunables) that can be fed to another software as configuration tokens or API invocations.

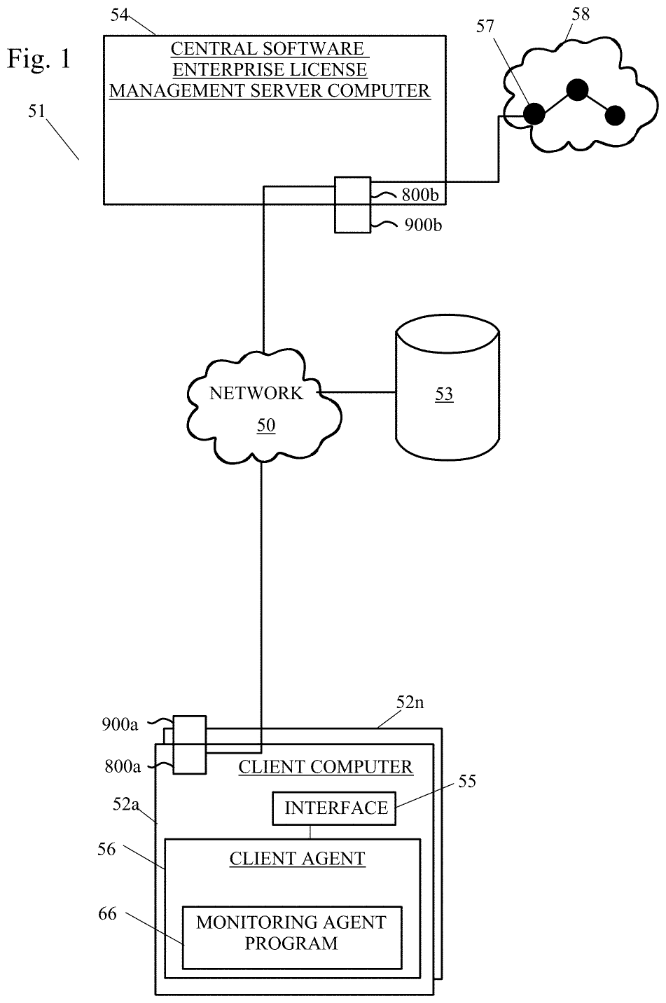

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, software licensing monitoring and detection system 51 is a network of computers in which illustrative embodiments may be implemented. Software licensing monitoring and detection system 51 contains network 50, which is the medium used to provide communication links between various devices and computers connected together within software licensing monitoring and detection system 51. Network 50 may include connections, such as wire, wireless communication links, or fiber optic cables.

In the depicted example, client computers 52a-52n of an organization and a central software license management (CSELM) server computer 54 connect to network 50. The CSELM server computer 54 is in communication with a remote application programming interface (API) endpoint 57, such as a cloud node of a cloud computing environment 58. In other exemplary embodiments, software licensing monitoring and detection system 51 may include additional client or client computers, storage devices or repositories, server computers, and other devices not shown. The CSELM server computer 54 utilizes cognitive services, a plurality of remote hosted services, which takes raw license natural language text as input, and provide the list of tunables as output. The plurality of services reflects plurality of methods through which the CSELM server computer 54 can avail the services. For example, one service uses the natural language license text as input as is, and returns the tunables. Another service takes the natural language license text as well as the language in which it was written as two inputs, and performs language translations internally.

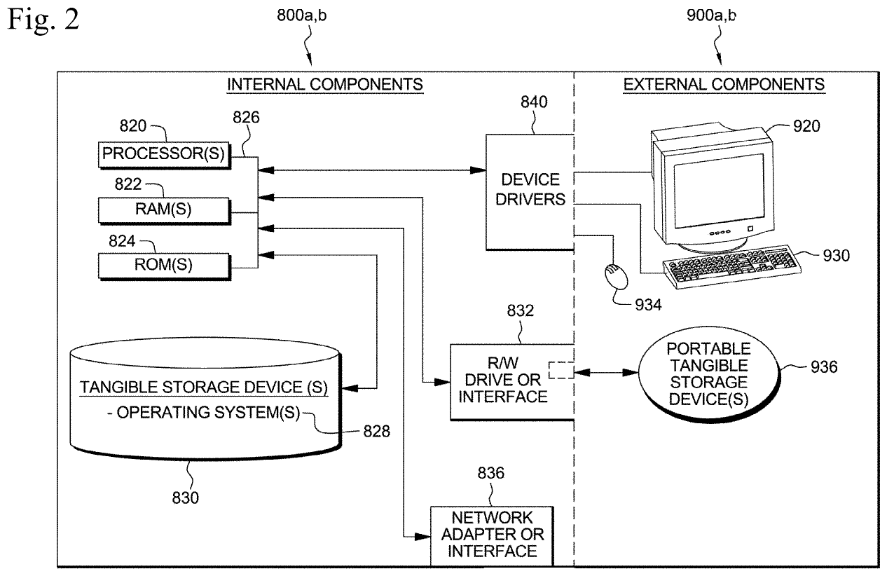

Each of the client computers 52a-52n of an organization may contain an interface 55, which may accept commands and data entry from a user. The commands may be regarding installation of software programs or products and other commands associated with installed software on the client computer 52a-52n. The interface 55 can be, for example, a command line interface, a graphical user interface (GUI), a natural user interface (NUI) or a touch user interface (TUI). Each client computer 52a-52n preferably includes a client agent 56 with a monitoring agent program 66. Each client computer 52a-52n includes a set of internal components 800a and a set of external components 900a, further illustrated in FIG. 2.

The CSELM server computer 54 includes a set of internal components 800b and a set of external components 900b illustrated in FIG. 2. In the depicted example, CSELM server computer 54 provides information, such as boot files, operating system images, commands associated with configuration files and applications to the client computer 52a-52n. The CSELM server computer 54 can compute the information locally or extract the information from other computers on network 50 or remote API endpoints 57 such as a cloud node of a cloud computing environment 58 utilizing a cloud model. Cloud computing utilizes service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

The cloud computing environment includes one or more cloud computing nodes or endpoints 57 with which local computing devices used by cloud consumers, such as, for example, the client computer 52a-52n. Nodes may communicate with one another. They may be grouped (not shown) physically or virtually, in one or more networks, such as Private, Community, Public, or Hybrid clouds as described hereinabove, or a combination thereof. This allows cloud computing environment to offer infrastructure, platforms and/or software as services for which a cloud consumer does not need to maintain resources on a local computing device.

Program code and programs such as client agent 56 and monitoring agent program 66 may be stored on at least one of one or more computer-readable tangible storage devices 830 shown in FIG. 1, on at least one of one or more portable computer-readable tangible storage devices 936 as shown in FIG. 2, or in a repository 53 connected to network 50, or may be downloaded to a client computer 52a-52n or CSELM server computer 54, for use. For example, program code and programs such as client agent 56 and monitoring agent program 66 may be stored on at least one of one or more storage devices 830 on CSELM server computer 54 and downloaded to client computer 52a-52n over network 50 for use. Alternatively, CSELM server computer 54 can be a web server, and the program code, and programs such as client agent 56 and monitoring agent program 66 may be stored on at least one of the one or more storage devices 830 on CSELM server computer 54 and accessed client computer 52a-52n. In other exemplary embodiments, the program code, and programs such as client agent 56 and monitoring agent program 66 may be stored on at least one of one or more computer-readable storage devices 830 on client computer 52a-52n or distributed between two or more servers.

In the depicted example, software licensing monitoring and detection system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, software licensing monitoring and detection system 51 also may be implemented as a number of different types of networks, such as, for example, an intranet, local area network (LAN), or a wide area network (WAN). FIG. 1 is intended as an example, and not as an architectural limitation, for the different illustrative embodiments.

FIG. 2 illustrates internal and external components of a client computers 52a-52n of an organization and CSELM server computer 54 in which illustrative embodiments may be implemented. In FIG. 2, client computers 52a-52n and a CSELM server computer 54 each include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, client agent 56, and monitoring agent program 66 are stored on one or more of the computer-readable tangible storage devices 830 for execution by one or more of the processors 820 via one or more of the RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Client agent 56 and monitoring agent program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Client agent 56 and monitoring agent program 66 can be downloaded to the client computer 52a-52n and CSELM server computer 54 from an external computer via a network (for example, the Internet, a local area network or other, wide area network) and network adapter or interface 836. From the network adapter or interface 836, client agent 56 and monitoring agent program 66 is loaded into hard drive 830. Client agent 56 and monitoring agent program 66 can be downloaded to the CSELM server computer 54 from an external computer via a network (for example, the Internet, a local area network or other, wide area network) and network adapter or interface 836. From the network adapter or interface 836, client agent 56 and monitoring agent program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Client agent 56 and monitoring agent program 66 can be written in various programming languages including low-level, high-level, object-oriented or non object-oriented languages. Alternatively, the functions of a client agent 56 and monitoring agent program 66 can be implemented in whole or in part by computer circuits and other hardware (not shown).

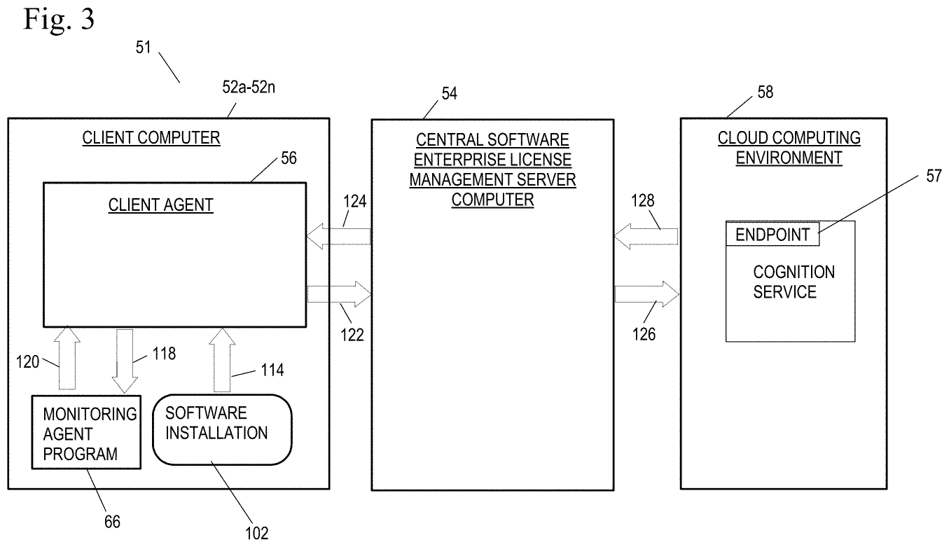

FIG. 3 shows a schematic of exemplary interactions between components of a software licensing monitoring and detection system.

The software licensing monitoring and detection system 51 contains CSELM server computer 54 in communication with a client agent 56 present in each of the plurality of client computers 52a-52n. The client agent 56 receives input from a monitoring agent program 66 present within each client computer 52a-52n. The monitoring agent program 66 has defined set of monitoring APIs and parameters/tunables.

The CSELM server computer 54 additionally communicates with an endpoint 57 of a cloud based software service of a cloud computing environment 58 that provides cognition remote based services for common license subscriptions. The cloud based software service of a cloud computing environment 58 uses natural language processing and deep learning to cognitively abstract keywords associated with the licensing restrictions for installed software products on the client computers 52a-52n. Deep learning is a technique of generating representations of input data at different levels of abstractions. In this context, supervised deep learning involves feeding heterogenous types of existing and known license text to the endpoint 57 of the cloud based software service, with characteristic features of the text properly labelled or tagged—examples: sentences that contain SHOULD, MUST, MUST NOT, MAY, and their classifications. The labelling or tagging will be absent in an unsupervised deep learning, instead by iterating over thousands of available and known license texts, appropriate abstractions are derived with the help of a knowledge corpus (general rules, ground truth, axioms, etc. that are available in the Internet). For both types of learning, Natural Language Processing and associated family of cognitive functions are leveraged extensively. Deep Learning techniques use deep learning libraries in creating the text summarization of the license document. Summarized text are then processed to extract the keywords along with nouns, verbs to understand the actual restrictions/actions in the text. In various implementations, supervised or unsupervised techniques may be employed.

The CSELM server computer 54 receives the abstract keywords associated with the licensing restrictions and generates a set of rules that represent the restrictions and sends the set of results to the monitoring agent program 66 via the client agent 56 to report, log and/or audit user actions that violate the defined rules.

The monitoring agent program 66 identifies and records actions by the user while using the software product and other actions, such as copying files, taking screen shots, modifying system registry, etc. and are compared with a configuration file that was supplied by the CSELM server computer 54 via the client agent 56 to determine whether the action was permissible per the software license terms. Actions that are identified as potentially violating the restrictions are sent to the CSELM server computer 54 for reporting, logging and auditing purposes.

As shown in FIG. 3, a client agent 56 intercepts 114 software being installed 102 extracts data 122 regarding at least the natural language licensing text from the installation bundle along with an audit trail. The audit trail is a series of records of computer events, about an operating system, an application, or user activities. The client agent 56 of the client computer 52a-52n preferably runs as a background process and listens and responds to software installation 102 requests from the user.

The client agent 56 is in communication with the CSELM server computer 54 through the network 50. The client agent 56 sends the extracted data 122 to the CSELM server computer 54.

The CSELM server computer 54 receives the extracted data 122 and the audit trail. The CSELM server computer 54 parses the installation audit trail to detect the type of software installation that was applied on the client computer 52a-52n—for example, standard, enterprise, multi user etc.

The audit trail preferably includes sufficient information to establish what events occurred and who (or what) caused them. In general, an event record of the audit trail should specify when the event occurred, the user ID associated with the event, the program or command used to initiate the event, and the result. Date and time can help determine if the user was a masquerader or the actual person specified.

The CSELM server computer 54 is preferably remote from the client computers 52a-52n as the client agent 56 and the monitoring agent program 66 which operate client side. The CSELM server computer 54 sends the natural language license text 126 associated with software installation 102 to an endpoint 57 of a cloud based software service of a cloud computing environment 58 that provides cognition based services for common license subscriptions.

The endpoint 57 is associated with a cognitive remote service 110 which, through natural language processing of the license terms and conditions in the locale of the user, applies a natural language processing feature to build abstraction on the content and determine restrictions. The cognitive remote services 110 of the endpoint 57 of the cloud computing environment 58 understands natural language text, is capable of translating licensing text into a normalized language, such as English, from a variety of locales, and is capable of digesting the input text to extract words, phrases, sentences and paragraphs that contain usage restrictions on the licensed content. This may be achieved through customized training in conjunction with deep learning algorithms

The cognitive remote services 110 of the endpoint 57 of the cloud computing environment 58 is additionally capable of further processing the extracted gist and transforming the data into pre-defined keywords that have 1-0-1 association with the parameters and the APIs for the monitoring agent program 66 on each of the client computers 52a-52n. The transformation may be achieved through data models that exemplify restrictions and associated tunable verbs, and then feeding this model to a deep learning algorithm.

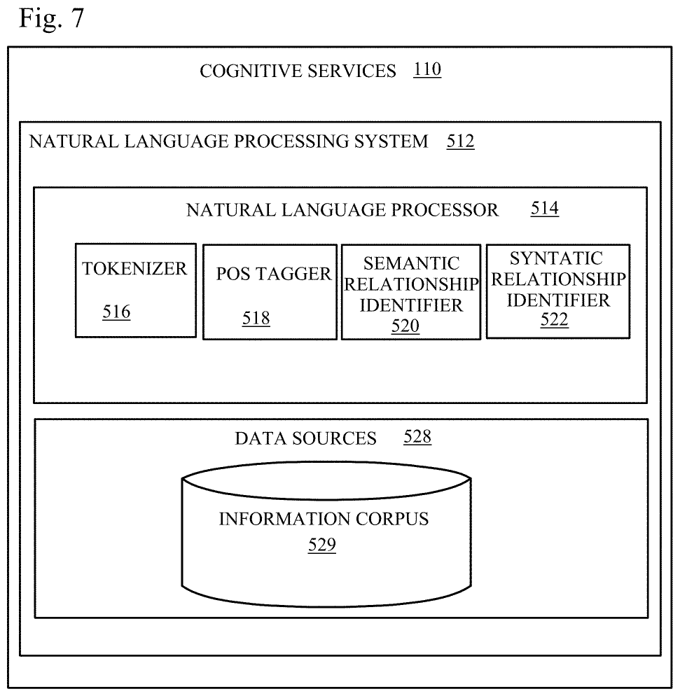

Referring now to FIG. 7, shown is a block diagram of an exemplary cognitive services architecture 500, including a natural language processing system 512, configured to extract usage restrictions from licensing terms and conditions of software products, in accordance with embodiments of the present disclosure.

In some embodiments, the natural language processing system 512 may include a natural language processor 514, and data sources 528.

The natural language processor 514 may be a computer module that analyzes the natural language licensing terms and conditions. The natural language processor 514 may perform various methods and techniques for analyzing electronic documents (e.g., syntactic analysis, semantic analysis, etc.). The natural language processor 514 may be configured to recognize and analyze any number of natural languages. In some embodiments, the natural language processor 514 may parse passages of the natural language documents. Further, the natural language processor 514 may include various modules to perform analyses of licensing terms and conditions. These modules may include, but are not limited to, a tokenizer 516, a part-of-speech (POS) tagger 518, a semantic relationship identifier 520, and a syntactic relationship identifier 522.

In some embodiments, the tokenizer 516 may be a computer module that performs lexical analysis. The tokenizer 516 may convert a sequence of characters into a sequence of tokens. A token may be a string of characters included in an electronic document and categorized as a meaningful symbol. Further, in some embodiments, the tokenizer 516 may identify word boundaries in an electronic document and break any text passages within the document into their component text elements, such as words, multiword tokens, numbers, and punctuation marks. In some embodiments, the tokenizer 516 may receive a string of characters, identify the lexemes in the string, and categorize them into tokens.

Consistent with various embodiments, the POS tagger 518 may be a computer module that marks up a word in passages to correspond to a particular part of speech. The POS tagger 518 may read a passage or other text in natural language and assign a part of speech to each word or other token. The POS tagger 518 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed electronic documents. Examples of parts of speech that may be assigned to words include, but are not limited to, nouns, verbs, adjectives, adverbs, and the like. Examples of other part of speech categories that POS tagger 518 may assign include, but are not limited to, comparative or superlative adverbs, wh-adverbs, conjunctions, determiners, negative particles, possessive markers, prepositions, wh-pronouns, and the like. In some embodiments, the POS tagger 518 may tag or otherwise annotate tokens of a passage with part of speech categories. In some embodiments, the POS tagger 518 may tag tokens or words of a passage to be parsed by other components of the natural language processing system 512.

In some embodiments, the semantic relationship identifier 520 may be a computer module that is configured to identify semantic relationships of recognized text elements (e.g., words, phrases) in documents. In some embodiments, the semantic relationship identifier 520 may determine functional dependencies between entities and other semantic relationships.

Consistent with various embodiments, the syntactic relationship identifier 522 may be a computer module that is configured to identify syntactic relationships in a passage composed of tokens. The syntactic relationship identifier 522 may determine the grammatical structure of sentences such as, for example, which groups of words are associated as phrases and which word is the subject or object of a verb. The syntactic relationship identifier 522 may conform to formal grammar.

In some embodiments, the natural language processor 514 may be a computer module that may parse a document and generate corresponding data structures for one or more portions of the document. For example, in response to receiving licensing terms and conditions text at the natural language processing system 512, the natural language processor 514 may output parsed text elements from the licensing text as data structures. In some embodiments, a parsed text element may be represented in the form of a parse tree or other graph structure. To generate the parsed text element, the natural language processor 514 may trigger computer modules 516, 518, 522.

In some embodiments, the output of the natural language processor 514 may be stored as an information corpus 529 in one or more data sources 528. In some embodiments, data sources 528 may include data warehouses, information corpora, data models, and document repositories. The information corpus 529 may enable data storage and retrieval. In some embodiments, the information corpus 529 may be a storage mechanism that houses a standardized, consistent, clean, and integrated copy of the ingested and parsed product reviews. Data stored in the information corpus 529 may be structured in a way to specifically address analytic requirements.

The output 128 of the cognitive remote service 110 is a full list of keywords that represents a relationship between a license restriction and a corresponding predefined tunable or parameter. This tunable or parameter also has a corresponding API that is exposed by the monitoring agent program 66. The output 128 is sent back to the CSELM server computer 54. The CSELM server computer 54 creates a configuration file with parameters 124 that are to be tracked, and monitored by the monitoring agent for each client computer to the client agent 56. The configuration file can include a process name as the key and the keywords as their values, representing the predefined tunable or parameter from the cognitive service 110 and passes this to the client agent.

More specifically, the CSELM server computer 54 passes the retrieved tunables composed into a list to the client agent 56 for the client agent 56 to apply to the client computer 52a-52n. In this case, the CSELM server computer 54 acts as a central entity that mediates between many such client requests and the cognitive services 110 of the endpoint 57 of the cloud computing environment 58. In another aspect of the invention, the CSELM server computer 54 filters the tunables/parameters based on the prevalent policies enforced by the organization.

For example, certain software may be subject to additional vendor agreements and/or special programs that the enterprise would have purchased outside the scope of the license. The CSELM server computer 54 is capable of altering or removing the tunables or parameters that represent restrictions in the usage of software that are retrieved from the cognitive services 110 but have been altered based on the enterprise's policies or special programs and thus acting as a policy enforcement server.

After receiving input from the CSELM server computer 54, the client agent 56 applies the configuration listings by modifying the configuration files with new entries and restarts or refreshes the monitoring agent program 66.

The monitoring agent program 66 of the client computer 52a-52n is controlled by a client agent 56. The monitoring agent program 66 preferably runs as a background service process and is capable of monitoring one or more user programs concurrent to a process (e.g. copying files, taking screen shots, modifying system registry etc.). The monitoring agent program 66 can also intercept low level system calls such as runtime level library calls that are invoked from the process being monitored. The monitoring agent program 66 additionally provides high level APIs for performing monitoring high level actions from a process as well monitor for changes and read its input from a configuration file and refresh its execution without having to restart the process.

The CSELM server computer 54 also receives and process status messages, log messages, and other data from individual client computers 52a-52n, through the client agent 56 from the monitoring agent program 66.

The monitoring agent program 66 sends audit trails 120 to the client agent 56 of any running software in which it is monitoring based on a pre-configured, definable parameters 118 as its input, and works at the system level to capture actions and map the parameters to high level through implementation specific logic.

An example of an installation audit trail is shown below.

>node-report@2.2.2 install home/user/Desktop/node_modules/node-report
>node-gyp rebuild

gyp info it worked if it ends with ok

gyp info ok

npm verb lifecycle node-report@2.2.2˜install: unsafe-perm in lifecycle true

npm verb lifecycle node-report@2.2.2˜install: PATH: /usr/local/lib/node_modules/npm/node_modules/npm-lifecycle/node-gyp-bin:home/user/Desktop/node_modules/node

report/node_modules/.bin:home/user/Desktop/node_modules/.biniusr/local/binlusr/bin:/b in:/usr/sbin:/sbin:/usr/local/go/bin:/usr/local/MacGPG2/bin:/opt/X11/bin

npm verb lifecycle node-report@2.2.2˜install: CWD:

home/user/Desktop/node_modules/node-report

npm timing audit submit Completed in 2733 ms

npm http fetch POST 200 https://registry.npmjs.org/-/npm/v1/security/audits/quick 3396 ms

npm timing audit body Completed in 699 ms

npm timing action:install Completed in 12182 ms

npm info lifecycle node-report@2.2.2˜postinstall: node-report@2.2.2

npm timing action:postinstall Completed in 1 ms

npm verb unlock done using home/used.npm/_locks/staging-7941825546bf8088.lock for home/user/Desktop/node_modules/.staging

npm timing stage:executeActions Completed in 13424 ms

npm timing stage:rollbackFailedOptional Completed in 0 ms

npm timing stage:runTopLevelLifecycles Completed in 84579 ms

npm WARN saveError ENOENT: no such file or directory, open ‘home/user/Desktop/package.json’

npm info lifecycle undefined˜preshrinkwrap: undefined

npm info lifecycle undefined˜shrinkwrap: undefined

npm notice created a lockfile as package-lock.json. You should commit this file.

npm info lifecycle undefined˜postshrinkwrap: undefined

+node-report@2.2.2

updated 1 package and audited 280361 packages in 97.409 s

found 11836 vulnerabilities (5817 low, 4135 moderate, 1825 high, 59 critical)

run ‘npm audit fix’ to fix them, or ‘npm audit’ for details

npm verb exit 0, true

npm timing npm Completed in 98042 ms

npm info ok

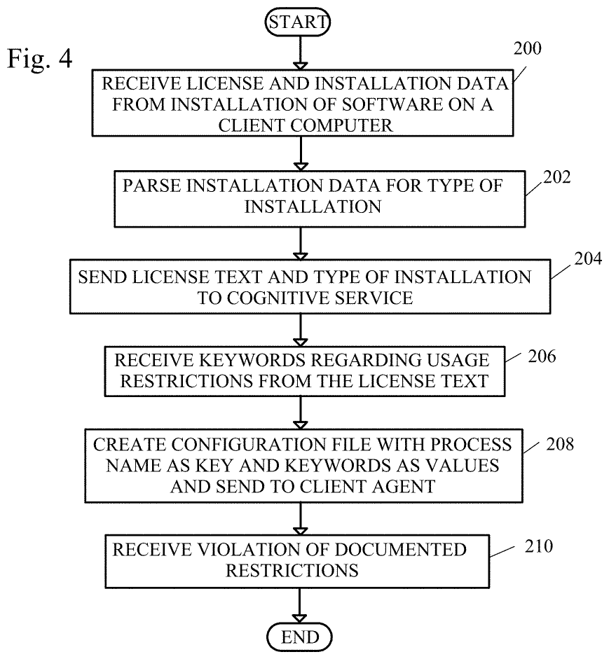

FIG. 4 shows a flow diagram of a method of the enterprise license management server detecting and monitoring of software license terms and conditions within an enterprise.

In a first step, the CSELM server computer receives installation data which includes at least natural language license terms and an audit trail from installation of software on a client computer via the client agent (step 200). Other data that may be present in the installation data from the client agent can include client computer information, such as serial number which can be used by the CSELM server computer 54 to match with records for uniquely identifying the workstation, type of computer, owner, division, etc.

The CSELM server computer parses the installation data to determine at least a type of installation of a software product on the client computer (step 202).

The CSELM server computer sends the natural language license terms and conditions text and type of installation to a cognitive service, such as a cloud based cognitive remote service (step 204).

The CSELM server computer receives from the cognitive remote service, predefined keywords that represent license restrictions and predetermined parameters with APIs from the license text (step 206).

The CSELM server computer creates a configuration file with at least a process name as a key and keywords as values and sends the configuration file to the client agent (step 208) and the method ends.

The key represents the process name that the monitoring agent program 66 should be monitoring henceforth. The keywords represent the actions that the process ‘may’ perform which the monitoring agent program should monitor or audit.

For example, {“name”: “X software”, “execPath”: C:\Program Files\X\bin\X.exe” “rules”: “InhibitDecompileDisassemble, InhitbitSourceCopy”, “audittrail”: C:\program Files\X\logs\audit.log” }. In this, the “X software” is the subject of monitoring, that is present in “C:\Program Files\X\bin\X.exe” location in the client computer 52a-52n, and the software actions pertinent to Decompilation and Disassembling of software code, copying of its source code are restricted as per the license, and those actions will be monitored. The audit trail, if any is generated by the monitoring agent program 66 is written to “C:\program Files\X\logs\audit.log” so that the client agent 56 can read the content and upload the same to the CSELM server computer 54 for post processing.

The CSELM server computer receives violations of the documented restrictions from the monitoring agent on the client computers via the client agent and stores the violations for logging and further processing (step 210) and the method ends.

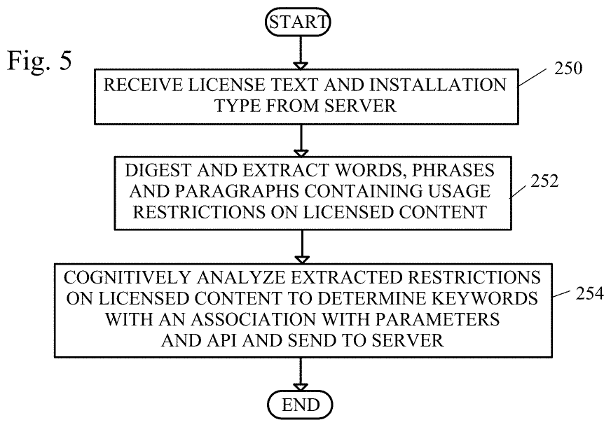

FIG. 5 shows a flow diagram of a method of the cognitive remote based remote services extracted licensing terms to cognitively analyze software licensing terms.

In a first step, the cognitive based services receives at least the natural language licensing text from the CSELM server computer (step 250).

The cognitive based services digest and extract words, phrases, and paragraphs from the natural language licensing text containing usage restrictions on the licensed content (step 252). Natural language processing may be used as described above.

The cognitive based services then analyses the extracted information to determine predefined keywords with a 1-0-1 association with parameters and APIs and sends the predefined keywords to the enterprise license management server (step 254) and the method ends.

The predefined keywords that are associated with the exposed APIs be and/or define capabilities of the monitoring agent program 66. In the deep learning methodology, the input data (natural language license text) is labelled or tagged with associated restrictions, and most relevant predefined keywords. Once the model is built, the cognitive service 110 is able to use it for generating the keywords against a specific portion of the input data.

For example, an excerpt of an natural language license text is:

The manufacturer of this software reserves all rights not expressly granted in this agreement. In particular, this license does not give you any right to:
(i) use or virtualize features of the software separately;
(ii) publish, copy, rent, lease or lend the software;
(iii) work around any technical restrictions or limitations in the software;
(iv) reverse engineer, decompile, or disassemble the software, or attempt to do so.

An example of a tunable or API which is the output from the cognitive remote services:

### InhibitVirtualiedExecution( )

### InhibitCopy( )

### InhibitMove( )

### InhibitFileModify( )

### InhibitBinaryEdit( )

### InhibitDiassemble( )

### InhibitDecompiler( )

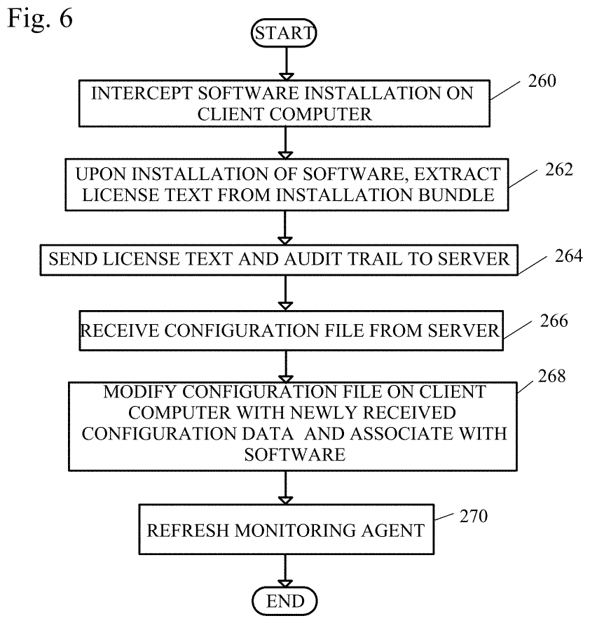

FIG. 6 shows a flow diagram of a method of the client agent managing the client computer.

The client agent intercepts software installation on a client computer (step 260). In an alternate embodiment, the monitoring agent program 66 can intercept the software installation and would then report such interceptions to the client agent.

The client agent, upon installation of the software onto the client computer extracts the natural language license and conditions text from the installation bundle (step 262). The installation bundle is one of an installable software or an installable software and its installer bundled together. The installation bundle preferably includes the post installation log and an associated audit trail. A post installation log is mostly generated within the bundle itself, and can also be present in user's (client computer user) personal folder. In some cases, the monitoring agent program 66 and/or client agent 56 can track or monitor the actions of the installer to find out what the installer is writing and associated audit data, since installers have a well known path for its audit trail.

The client agent then sends the extracted natural language license text and audit trail to the CSELM server computer (step 264).

The client agent receives a configuration file from the CSELM server computer (step 266).

The client agent modifies the current configuration file on the client computer with the newly received configuration file and data and associates the configuration file with the installed software (step 268).

The client agent refreshes the monitoring agent program in order for the newly configuration file to apply to the client computer (step 270) and the method ends.

### Example

A user installs software called Too′ on a client computer of an organization of an enterprise.

The client agent 56 intercepts the installation and sends installation data such as the audit trail and the extracted license terms in natural language text to the CSELM server computer 54. The CSELM server computer 54 then parses the installation type from the installation data from the client agent 56.

The CSELM server computer 54 sends the extracted natural language license text or terms and conditions to the cognitive services 110 of the cloud computing environment 58.

The cognitive services 110 detects a phrase that contains restrictions for usage of the installed software and sends the phrase to the CSELM server computer 54. An example of a natural language text restriction found may be, “You may not decompile, reverse engineer, disassemble, derive the source code of [this] software or security components of the Services, Site, or of the Content or attempt to do any of the same.”

The CSELM server computer 54 cognitively analyzes the phrase into a set of commands based on a rules engine to be:
InhibitDecompileDisassemble( ) InhitbitSourceCopy( )

The CSELM server computer 54 creates a configuration file including the restrictions and sends the configuration file to the client agent 56 and the client agent 56 reconfigures a configuration file associated with the monitoring agent program 66 to contain:

{

“name” :“foo”,
“execPath” : C:\Program Files\foo\bin\foo.exe”
“rules” : “InhibitDecompileDisassemble, InhitbitSourceCopy”
“audittrail”: C:\program Files\foo\logs\audit.log”

}

Where:
“name” uniquely identifies the software that is subjected for monitoring.
“execPath” describes the installation path for the software ‘foo’
“rules” define restricted actions such as disassemble or unauthorized copy of the software ‘foo’.

Each rule that the CSELM server computer 54 defines has a one-to-one correspondence with a matching capability in the monitoring agent program 66. This way, the monitoring agent program 66 is capable of monitoring any software.

The client agent then restarts the monitoring agent with the updated configuration file. At predefined intervals, audit logs for the client computer are accessed, read and sent to the server. The audit logs may be stored. Any violations present within the audit logs can be flagged and sent to the administrators.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of detecting and monitoring of natural language software license terms and conditions within an enterprise system, the enterprise system comprising a plurality of client computers each having a client agent with monitoring agent, the client agent of each of the plurality of client computers being in communication with a central software enterprise license management server computer, the central software enterprise license management server computer being in communication with remote hosted services, the method comprising the steps of:
the client agent of at least one client computer of the plurality of client computer intercepting installation of software on the at least one client computer and upon installation of the software, extracting installation data comprising: natural language licensing text of software license terms and conditions from the installation of the software and an audit trail associated with the installation of the software;
the central software enterprise license management server receiving the installation data from the client agent and parsing the installation data to determine a type of installation of the software on the at least one client computer;
the remote hosted services receiving the natural language licensing text and type of installation from the central software enterprise license management server computer and abstracting licensing restrictions from the natural language licensing text;
the central software enterprise license management server computer receiving the abstracted licensing restrictions from the remote hosted services and generating a configuration file with a set of rules that represent the restrictions abstracted for implementation by the client agent of the at least one client computer;
the client agent invoking the configuration file through the monitoring agent with the set of rules identified for the installation of the software on the at least one client computer; and
the monitoring agent reporting, logging or auditing user actions that violate the set of rules of the configuration file identified for the installation of the software on the client computer.

2. The method of claim 1, wherein abstracting licensing restrictions from the natural language licensing text comprises the steps of:
digesting and extracting words, phrases, and paragraphs containing usage restrictions on licensed natural language licensing text of the installed software; and
cognitively analysing extracted restrictions on natural language licensing text to determine keywords with an association with parameters and application programming interfaces.

3. The method of claim 1, wherein the remote hosted services are cloud based.

4. The method of claim 1, wherein the configuration file created by the the central software enterprise license management server computer comprises at least one process name as a key and keywords as values.

5. The method of claim 1, wherein the audit trail comprises a series of records of computer events of the at least one client computer, records about an operating system, an application, or user activities of the at least one client computer.

6. The method of claim 1, wherein the cognitive services cognitively abstracts licensing restrictions from the natural language licensing text by natural language processing and deep learning.

7. A computer program product for detecting and monitoring of natural language software license terms and conditions within an enterprise system, the enterprise system comprising a plurality of client computers each having a computer comprising at least one processor, one or more memories, one or more computer readable storage media, a client agent with monitoring agent, the client agent of each of the plurality of client computers being in communication with a central software enterprise license management server computer, the central software enterprise license management server computer being in communication with remote hosted services, the computer program product comprising a computer readable storage medium having program instructions embodied therewith, the program instructions executable by the computer to perform a method comprising:
intercepting, the client agent of at least one client computer of the plurality of client computer, installation of software on the at least one client computer and upon installation of the software, extracting installation data comprising: natural language licensing text of software license terms and conditions from the installation of the software and an audit trail associated with the installation of the software;
receiving, by the central software enterprise license management server, the installation data from the client agent and parsing the installation data to determine a type of installation of the software on the at least one client computer;
receiving, by the cognitive services, the natural language licensing text and type of installation from the central software enterprise license management server computer and abstracting licensing restrictions from the natural language licensing text;
receiving, by the central software enterprise license management server computer, the abstracted licensing restrictions from the remote hosted services and generating a configuration file with a set of rules that represent the restrictions abstracted for implementation by the client agent of the at least one client computer;
invoking, by the client agent, the configuration file through the monitoring agent with the set of rules identified for the installation of the software on the at least one client computer; and
reporting, logging or auditing, by the monitoring agent, user actions that violate the set of rules of the configuration file identified for the installation of the software on the client computer.

8. The computer program product of claim 7, wherein abstracting licensing restrictions from the natural language licensing text comprises the program instructions of the central software enterprise license management server computer:
digesting and extracting words, phrases, and paragraphs containing usage restrictions on natural language licensing text of the installed software; and
cognitively analysing extracted restrictions on the natural language licensing text to determine keywords with an association with parameters and application programming interfaces.

9. The computer program product of claim 7, wherein the remote hosted services are cloud based.

10. The computer program product of claim 7, wherein the configuration file created by the the central software enterprise license management server computer comprises at least one process name as a key and keywords as values.

11. The computer program product of claim 7, wherein the cognitive services cognitively abstracts licensing restrictions from the natural language licensing text by natural language processing and deep learning.

12. The computer program product of claim 7, wherein the audit trail comprises a series of records of computer events of the at least one client computer, records about an operating system, an application, or user activities of the at least one client computer.

13. A computer system for detecting and monitoring of natural language software license terms and conditions within an enterprise system, the enterprise system comprising a plurality of client computers comprising at least one processor, a client agent with monitoring agent, the client agent of each of the plurality of client computers being in communication with a central software enterprise license management server computer, the central software enterprise license management server computer being in communication with remote hosted services, one or more computer readable storage media having program instructions executable by the computer to perform the program instructions comprising:
intercepting, the client agent of at least one client computer of the plurality of client computer, installation of software on the at least one client computer and upon installation of the software, extracting installation data comprising: natural language licensing text of software license terms and conditions from the installation of the software and an audit trail associated with the installation of the software;
receiving, by the central software enterprise license management server, the installation data from the client agent and parsing the installation data to determine a type of installation of the software on the at least one client computer;
receiving, by the cognitive services, the natural language licensing text and type of installation from the central software enterprise license management server computer and abstracting licensing restrictions from the natural language licensing text;
receiving, by the central software enterprise license management server computer, the abstracted licensing restrictions from the remote hosted services and generating a configuration file with a set of rules that represent the restrictions abstracted for implementation by the client agent of the at least one client computer;
invoking, by the client agent, the configuration file through the monitoring agent with the set of rules identified for the installation of the software on the at least one client computer; and
reporting, logging or auditing, by the monitoring agent, user actions that violate the set of rules of the configuration file identified for the installation of the software on the client computer.

12. The computer system of claim 13, wherein abstracting licensing restrictions from the natural language licensing text comprises the program instructions of the central software enterprise license management server computer:
digesting and extracting words, phrases, and paragraphs containing usage restrictions on natural language licensing text of the installed software; and
cognitively analysing extracted restrictions on the natural language licensing text to determine keywords with an association with parameters and application programming interfaces.

14. The computer system of claim 13, wherein the remote hosted services are cloud based.

15. The computer system of claim 13, wherein the configuration file created by the the central software enterprise license management server computer comprises at least one process name as a key and keywords as values.

16. The computer system of claim 13, wherein the remote hosted services cognitively abstracts licensing restrictions from the natural language licensing text by natural language processing and deep learning.

17. The computer system of claim 13, wherein the audit trail comprises a series of records of computer events of the at least one client computer, records about an operating system, an application, or user activities of the at least one client computer.
